(19) United States
(12) Patent Application Publication
(10) Pub. No.: US 2018/0003376 A1
(43) Pub. Date: Jan. 4, 2018

(54) Candle Seal

(71) Applicant: Paralee Thiefault, Lake Worth, FL (US)

(72) Inventor: Paralee Thiefault, Lake Worth, FL (US)

(21) Appl. No.: 15/196,901

(22) Filed: Jun. 29, 2016

(51) Int. Cl. F21V 35/00; B65D 25/24

(52) U.S. Cl. CPC F21V 35/006; B65D 25/24

(57) ABSTRACT

The present invention provides a candleholder for use with candle to collect the dripping wax. The candleholder comprises a rigid cylindrical sleeve with an open top and an open bottom, and a base configured to releasably couple to the open bottom of the cylindrical sleeve. The candleholder is dimensioned such that to receive the candle and the candle is supported on the base while having a small amount of empty space around the candle for collecting the dripped wax. The bottom surface of the base further comprises a protrusion configured to fit into pocket of a conventional candlesticks or stands.

### CROSS REFERENCE TO RELATED APPLICATION

Not Applicable

### FEDERALLY SPONSORED RESEARCH AND DEVELOPMENT

Not Applicable

### MICROFICHE APPENDIX

Not Applicable

### BACKGROUND

### (1) Field of Invention

The present invention generally relates to a candle holder and in particular, to candle holder that collects dripping wax.

### (2) Background of Invention

The use of candles in decorations is well known and candles of different colors and designs have been widely used. Furthermore, candle stands of aesthetic designs have also been used to enhance the appearance of candle and the candle are also popularly used with other decorations.

The candles are generally made from wax material and burning of wax candles has a fretting problem of dripping wax. The melted wax drips to side of candles and get deposit on surface or candle-stand or to any side by decorations. The deposited wax is difficult to remove and adversely affects the appearance of candle-stand or side by decoration, and furthermore the melted wax is hot enough to damage any delicate surface encountering melted wax.

Prior art disclosing drip-preventing devices include a U.S. Pat. No. 6,264,345 issued to “The Candle Machine Co.” discloses a drip-preventing candleholder, which provides auxiliary illumination at a location remote from the candle flame. Another U.S. Pat. No. 6,220,855 issued to “Steven K. Asheim” teaches a candle-stand and wax recycling assembly for capturing, retaining, and forming wax run-off from a first candle as the first candle burns during use. The candle-stand and wax recycling assembly includes a platform assembly adapted for supporting a first candle, a receptacle coupled beneath said platform assembly adapted for receiving melted wax, a wick member, and a wick holding assembly. Yet another U.S. Pat. No. 6,443,364 issued to Lin Chung-Kuei discloses a candle-stand in combination with a fountain that has rearrangeable components to provide a variety of configurations for ornamental purpose.

It is clear that a need exists to provide a candleholder that could be used with conventional candle stands for collecting the dripped wax.

### BRIEF SUMMARY OF THE INVENTION

The present invention, therefore, has as its principal object to provide a candleholder for collecting the dripping wax.

Another object of present invention is that the candleholder could be used with other candle stands or sticks.

A further object of present invention is that the candleholder could have aesthetic designs.

Yet another object of present invention is that the candleholder is economical to manufacture.

Certain embodiments of the present invention provide a candleholder for use with candle to collect the dripping wax. The candleholder according to one exemplary embodiment of present invention comprise a rigid cylindrical sleeve with an open top and an open bottom, and a base configured to releasably fit to the open bottom of the cylindrical sleeve. In another embodiment, the rigid cylindrical sleeve is dimensioned such that to receive the candle and supported on the base while having a small amount of empty space around the candle i.e. between the candle and lateral walls of the cylindrical sleeve, for collecting the dripped wax. In another embodiment, the cylindrical sleeve could be produced in different sizes according to different sizes candle. In another embodiment, the candleholder according to present invention could have a diameter in range 2-3 in., and the height in the range of 3-8 in.

In another exemplary embodiment of present invention the base further comprise a protrusion extended from lower surface of the base and downwards. The protrusion is configured to releasably and frictionally fit into the pocket of a conventional candlestick or stand for holding the candleholder of present invention on a conventional candlestick or stand.

In another exemplary embodiment of present invention, the base comprise one or more suction cups positioned on the bottom surface of the base and adapted to adhere to the surface upon which the candle-stand of present invention is placed. The use of suction cups stabilizes the candle on the surface and permit convenient placement and moving of the candle mounted in the candleholder of present invention along with the surface.

In another exemplary embodiment of present invention, the cylindrical sleeve could be made from material that are flame resistant for example, glass could preferably be used that is both transparent and easy to clean. Furthermore plastics could also be used that are resistant to fire.

In addition to the various objects and advantages of the present invention described with some degree of specificity above it should be obvious that additional objects and advantages of the present invention will become more readily apparent to those persons who are skilled in the relevant art from the following more detailed description of the invention.

### BRIEF DESCRIPTION OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 illustrates one embodiment of a candle-stand showing the sleeve, base, and a protrusion extending from the base.

FIG. 2 illustrates another embodiment of present invention showing the sleeve and base.

### DETAIL DESCRIPTION OF THE INVENTION

The present invention provides an apparatus for use with wax candles for collecting the dripping wax.

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

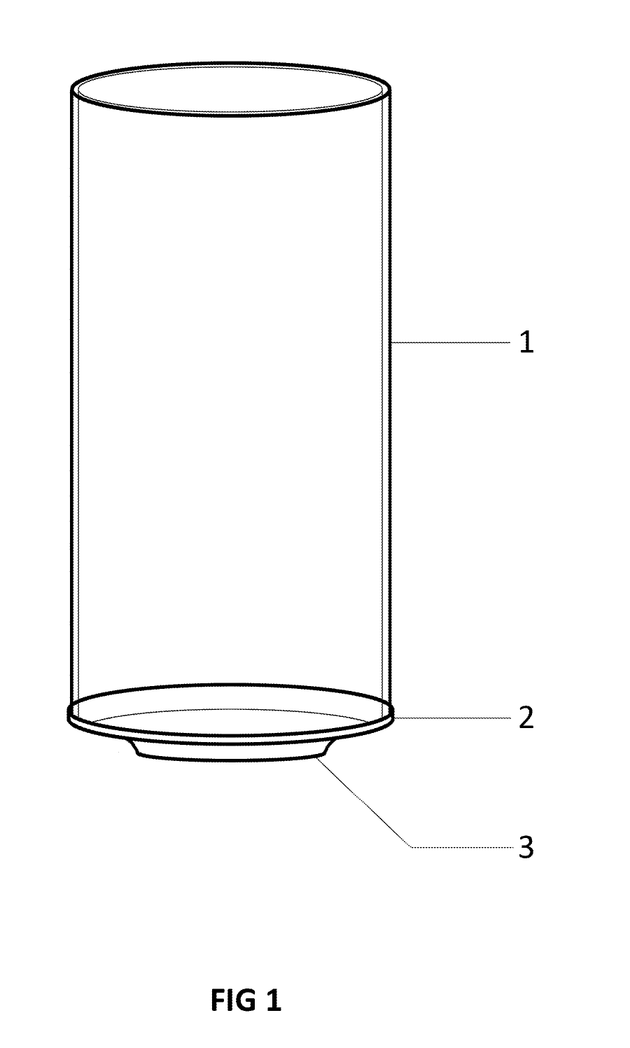

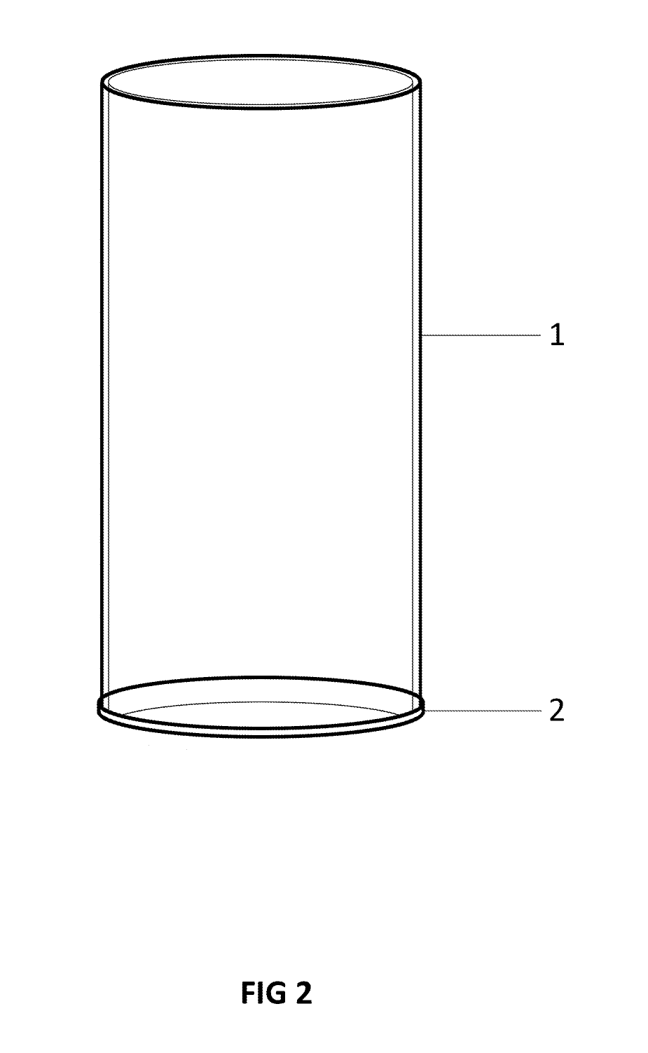

Looking to FIGS. 1-2, there is illustrated an embodiment of the present invention, which discloses a candleholder for use with candle to collect the dripping wax. As shown in the FIG. 1, the candleholder includes a rigid cylindrically shaped sleeve 1 that is adapted to receive the candle. The diameter of the sleeve should be larger than the candle such as when the candle is received into the sleeve, small space is available around the candle. The space around the candle should be sufficient to allow the dripping wax to collect at bottom and the wax not touching the walls of the sleeve. It is obvious that the candles are produced in different sizes, and thus the candle sleeve could be produced according to the candle sizes. Preferably the sleeve could be produced in various standard sizes for example 2×3 in. wherein 2 in is the diameter and 3 in. is the height of sleeve, and similarly 2×6 in., 3×5 in., 3×6 in., 3×8 in. The sleeve could be produced from materials such as plastic, glass etc., preferably the material used in making the sleeve is resistant to fire, for example glass could be used as the glass is transparent and is resistant to fire and chemicals. Besides glass, heat resistant plastics are also known, for example, polyvinyl chloride that has an advantage over glasses being unbreakable.

The cylindrical sleeve has an open top, an open bottom, and a side wall/lateral wall, said lateral wall having a top edge and a bottom edge. The top of sleeve should be open to receive the candle, and the received candle is supported on a base 2, which closes the open bottom of the sleeve. The base is provided to releasably fit to the open bottom of the cylindrical sleeve. This permit disassembling of the candleholder to separate the base from the sleeve for removal of deposited wax and further allows attachment of different bases to the sleeve. For releasably fitting, the base and the sleeve could have fastening mechanism, for example, a skirt may be provided on top surface or edge of the base wherein the skirt could juxtapose around the periphery of the bottom edge of the sleeve and is frictionally retain. Furthermore, the skirt could be made of rubber or have the lining of a rubber or any other soft material for frictionally securing the base to the sleeve, for example, such mechanism is obvious in snap fit lid and containers. Alternatively, screw mechanism could also be used wherein the skirt and the sleeve could have threads for fastening the base to the sleeve. Other mechanisms such as use of clips or brackets could also be used. In addition, suction cups could also be provided with suction cups for firmly securing the candleholder to a surface. The use of suction cups could be advantageous in case the candleholder along with the surface on which the candleholder is placed have to be moved.

The base could be made from materials such as plastic, metals, rubber etc. Preferably, the material used in making the base can be heat resistant or the material could sustain the temperature of melted wax. The bottom surface of the base is adapted for placing the candleholder on a surface such as tabletop, a bottom wall of a container etc. The surface could be even or rough and thus the bottom surface of base could be adapted to different types of surfaces for example, the base could have a lining of rubber to provide adherence to the surface. Alternatively, rubber cushions could be provided or multiple ribs or ridges could be provided on bottom surface of the base. In a preferred embodiment, as shown in FIG. 1, a protrusion 3 could be provided extending from the bottom surface of the base. The protrusion is used to mount the candleholder on a conventional candle stands or candlesticks etc. The conventional candle-stand usually have a pocket to support the candle, the protrusion is dimensionally adapted to releasably and frictionally retain in such pockets for mounting the candleholder of present invention. It is obvious that different conventional stands could have different dimensions of the pocket, so interchangeable bases could be provided. The bases having different size protrusions according to the dimension of the pockets could be provided and suitable base could be coupled to the sleeve.

It is to be understood that the candleholder encompasses a variety of alternatives. For example, the sleeve could be produced in shapes other than cylindrical, for example, square shape, triangle shape, or the sleeve made of multiple walls. Furthermore, the candles are available in different shapes for example square shape candle and the shape of sleeve could be produced according to the shape of the candle. In addition, the sleeve could have various designs and indicia providing aesthetic appearance to the candleholder.

What is claimed is:

1. A candleholder for mounting a candle and collecting a dripped wax from said candle, said candleholder comprising:
a. a rigid cylindrically shaped sleeve having an open top, an open bottom and a lateral wall, said lateral wall having a top edge and a bottom edge, said sleeve adapted to receive said candle such that leaving a sufficient empty space around said candle for collecting said dripped wax and the dripped wax not touching said top edge;
b. a base configured to releasably couple to said bottom edge and adapted to support said candle; and
c. a protrusion extending from a bottom surface of said base, said protrusion configure to releasably mount said candleholder on a conventional candle-stand.

2. The candleholder of claim 1, wherein said candle is a candle made of wax and having at least one wick.

3. The candleholder of claim 1, wherein said rigid cylindrically shaped sleeve is made of a glass.

4. The candleholder of claim 1, wherein said rigid cylindrically shaped sleeve is made of a heat resistant plastic.

5. The candleholder of claim 1, wherein said protrusion is dimensioned to releasably and frictionally retain in a pocket of said conventional candle-stand, said base is selected from a plurality of bases having different protrusions.

6. A candleholder for mounting a candle and collecting a dripped wax from said candle, said candleholder comprising:
a. a rigid cylindrically shaped sleeve having an open top, an open bottom and a lateral wall, said lateral wall having a top edge and a bottom edge, said sleeve adapted to receive said candle such that leaving a sufficient empty space around said candle for collecting said dripped wax and the dripped wax not touching said top edge; and
b. a base configured to releasably couple to said bottom edge and adapted to support said candle, said base having a bottom surface adapted to place said candleholder on a surface.

7. The candleholder of claim 6, wherein said base further comprising at least one sucker cup protruding from said bottom surface for stabilizing said candleholder on said surface.

8. The candleholder of claim 6, wherein said base further comprises a plurality of ridges on said bottom surface for stabilizing said candleholder on said surface.

9. The candleholder of claim 6, wherein said candle is a candle made of wax and having at least one wick.

10. The candleholder of claim 6, wherein said rigid cylindrically shaped sleeve is made of a glass.

11. The candleholder of claim 6, wherein said rigid cylindrically shaped sleeve is made of a heat resistant plastic.
